(19) United States
(12) Patent Application Publication
(10) Pub. No.: US 2008/0287178 A1
(43) Pub. Date: Nov. 20, 2008

(54) Floating reel gaming activity

(76) Inventors: Bradley Berman, Minnetonka, MN (US); Rebecca Schuh, Long Grove, IL (US); Jason Malkovich, Chaska, MN (US)

Correspondence Address: Hollingsworth & Funk, LLC;Suite 125, 8009 34th Avenue South, Minneapolis, MN, 55425, US

(21) Appl. No.: 12/077,720

(22) Filed: Mar. 20, 2008

Related U.S. Application Data
(60) Provisional application No. 60/919,359, filed on Mar. 22, 2007.

(51) Int. Cl. A63F 9/24; A63F 13/00

(52) U.S. Cl. 463/20

(57) ABSTRACT

A floating reel strip gaming activity involves randomly arranging first symbols on a plurality of gaming reels in response to a gaming event. Second symbols are randomly arranged on a floating reel in response to the gaming event. The floating reel is positioned over the plurality of gaming reels in response to the gaming event so that at least one of the second symbols are superimposed on at least one of the first symbols. A payout is determined in response to the gaming event based on the arrangement of the first symbols in combination with the second symbols.

### RELATED APPLICATIONS

This application claims the benefit of Provisional Application No. 60/919,359, filed on Mar. 22, 2007, to which priority is claimed pursuant to 35 U.S.C. § 119(e), and which is hereby incorporated herein by reference in its entirety.

### FIELD OF THE INVENTION

This invention relates in general to games, and more particularly to apparatuses and methods for wagering games.

### BACKGROUND OF THE INVENTION

Casino games such as poker, slots, and craps have long been enjoyed as a means of entertainment. Almost any game of chance that can be played using traditional apparatus (e.g., cards, dice) can be simulated on a computer. The popularity of casino gambling with wagering continues to increase, as does recreational gambling such as non-wagering computer game gambling. It is also likely that most new games will be implemented, at least in part, using computerized apparatus.

One reason that casino games are widely implemented on computerized apparatus is that computerized games are highly adaptable, easily configurable and re-configurable, and require minimal supervision to operate. For example, the graphics and sounds included in such games can be easily modified to reflect popular subjects, such as movies and television shows.

Computer gaming devices can also be easily adapted to provide entirely new games of chance that might be difficult to implement using mechanical or discrete electronic circuits. Because of the ubiquity of computerized gaming machines, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill. In some jurisdictions, the absence of skill when determining awards during game play is a requirement.

The present disclosure describes methods, systems, and apparatus that provide for new and interesting gaming experiences, and that provide other advantages over the prior art.

### SUMMARY OF THE INVENTION

To overcome limitations in the prior art described above, and to overcome other limitations that will become apparent upon reading and understanding the present specification, the present invention discloses a gaming apparatus that includes a plurality of gaming reels each having a plurality of first symbols that are randomly arranged in response to a gaming event. The apparatus includes a floating reel having a plurality of second symbols that are randomly arranged in response to the gaming event. The floating reel is overlaid on the plurality of gaming reels in response to the gaming event so that at least one of the second symbols are superimposed at least one of the first symbols. The apparatus further includes payout device that determines a payout based on the arrangement of the first symbols in combination with the second symbols in response to the gaming event.

In more particular embodiments, the at least one second symbol replaces the at least one first symbol, and the payout device determines the payout based on the replacement of the at least one first symbol by at least one the second symbol. In one arrangement, the at least one second symbol includes a wild symbol. In another arrangement, the at least one second symbol is combined with the at least one first symbol to create a composite symbol, and the payout device determines the payout based on the composite symbol. In such a case, the composite symbol is capable of taking on either value of the at least one first and second symbols when the payout is determined. In another arrangement using a composite symbol, the composite symbol causes a multiplier to be applied when the payout is determined for any payouts associated with the composite symbol.

In other more particular embodiments, the floating reel contains a plurality of cells filled each filled with the same selected symbol. A first set of the cells are defined based on the selected symbols of the first set of cells matching at least one of the first symbols over which the selected symbols are respectively superimposed when the floating reel is overlaid on the plurality of gaming reels, and the payout device determines the payout based on the first set of cells.

In other more particular embodiments, the at least one second symbol includes an expanding wild symbols that causes all symbols of a gaming reel of the plurality of gaming reels over which the expanding wild symbol is superimposed to change to wild symbols. In another arrangement, the gaming event includes a primary game event and a bonus game event, and the floating reel is overlaid on the plurality of gaming reels in response to the bonus game event. In such a case, the payout device determines the payout based on the arrangement of the first symbols in combination with the second symbols in response to the bonus game event.

In another embodiment of the invention, a method involves randomly arranging first symbols on a plurality of gaming reels in response to a gaming event and randomly arranging second symbols on a floating reel in response to the gaming event. The floating reel is positioned over the plurality of gaming reels in response to the gaming event so that at least one of the second symbols are superimposed on at least one of the first symbols. In response to the gaming event, a payout is determined based on the arrangement of the first symbols in combination with the second symbols.

In another embodiment of the invention, a gaming apparatus includes: means for randomly arranging first symbols o in response to a gaming event; means for randomly arranging second symbols so that at least one of the second symbols are superimposed on at least one of the first symbols in response to the gaming event; and means for determining, in response to the gaming event, a payout based on the arrangement of the first symbols in combination with the second symbols.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1. is a diagram of a gaming machine according to an embodiment of the invention;

FIG. 2 is a sequence diagram showing a sequence of gaming screens in a gaming apparatus according to an embodiment of the invention;

FIG. 3 is a sequence diagram showing an alternate sequence of gaming screens in a gaming apparatus according to an embodiment of the invention;

FIG. 4 is a sequence diagram showing another alternate sequence of gaming screens in a gaming apparatus according to an embodiment of the invention;

FIGS. 5A-D are block diagrams illustrating various resulting combinations of a floating reel symbol with a base reel symbol in a gaming apparatus according to an embodiment of the invention;

FIG. 6 is a sequence diagram showing another alternate sequence of gaming screens in a gaming apparatus according to an embodiment of the invention;

FIG. 7 is a block diagram illustrating a multiple floating reel gaming arrangement according to an embodiment of the invention;

FIG. 8 is a flowchart illustrating a gaming procedure according to an embodiment of the invention; and

FIG. 9 is a block diagram illustrating a computing arrangement according to an embodiment of the invention.

### DETAILED DESCRIPTION OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present invention relates to a wagering game that may resemble a reel-type gaming apparatus such as slot machines. Generally, an apparatus provides a gaming activity that involves randomly arranging symbols in such a way as to provide a payout. A commonly implemented form of this activity involves using a number of side-by-side circular reels that spin on the same axis. These reels may be mechanical devices (e.g., wheels or hoops) or may be simulated via a computer and video display. The reels have symbols printed on them, and the player is provided a monetary award when the selected symbols form a pattern, such as when a horizontal line that spans all the reels has the same symbol. This line that connects symbols is sometimes referred to as the pay line (or payout line), and pay lines may also be diagonal or other shapes besides a line.

In an apparatus according to an embodiment of the invention, a secondary sequence of symbols is presented so as to appear as a reel or other arrangement that rotates on a different axis than the primary reels. For example, where the primary reels are vertically arranged (e.g., rotating about a horizontal axis) the secondary reel may be arranged horizontally (e.g., rotating about a vertical axis). The secondary reel is superimposed, overlaid, floating, or otherwise made to appear on top of the primary reels. The secondary reel may also be translated relative to the primary reels, so that the some symbols of the secondary reel are superimposed over some symbols of the primary reels. Generally, when the secondary reels are placed over the primary reels, the payout accorded by the primary reels may be altered in some way. For example, the secondary reel may contain a random arrangement of wild symbols that can take any symbol value and thus increase the odds of a payout. The secondary reel may be part of primary game play and/or secondary or bonus play.

In the description that follows, the term “reels,” “reel strips,” and similar mechanically descriptive language may be used to describe various apparatus presentation features. Although the present disclosure may be applicable to both to mechanical and computerized embodiments, and any combination therebetween, the use of mechanically descriptive terms is not meant to be only applicable to mechanical embodiments. Those skilled in the art will understand that, for purposes of providing gaming experiences to players, mechanical elements such as reels may be simulated on a display in order to provide a familiar and satisfying experience that emulates the behavior of mechanical objects. Further, the computerized version may provide the look of a reel (e.g., a linear arrangement of symbols) but are randomized in a way different than a spinning reel, such as by randomly and independently changing each cell of the reel that has a symbol. Thus, the term “reels,” “reel strips,” etc. are intended to describe both physical objects and emulation or simulations of those objects using electronic apparatus.

In various embodiments of the invention, the gaming displays are described in conjunction with the use of data in the form of “symbols.” In the context of this disclosure, a “symbol” refers to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing the symbol with another symbol. Generally, such comparisons can be performed via software by mapping numbers (or other data structures such as character strings) to the symbols and performing the comparisons on the numbers/data structures.

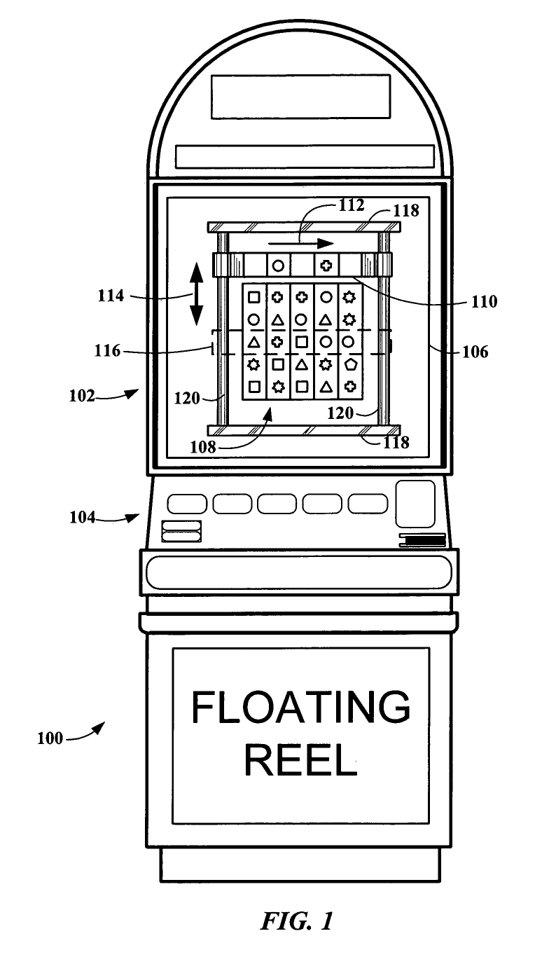

In reference now to FIG. 1, a gaming machine 100 is illustrated that provides a gaming experience according to an embodiment of the invention. The illustrated gaming machine 100 may include a computing system (not shown) to carry out operations according described herein. The gaming machine 100 includes a display 102, and a user interface 104, although some or all of the user interface 104 may be provided via the display 102 in touch screen embodiments. The user interface 104 allows the user to control and engage in play of the gaming machine 100. The particular user interface mechanisms included with user interface 104 may be dependent on the type of gaming machine. For example, the user interface 104 may include one or more buttons, switches, joysticks, levers, pull-down handles, trackballs, voice-activated input, or any other user input system or mechanism that allows the user to play the particular gaming activity.

The user interface 104 may allow the user to enter coins, bills, or otherwise obtain credits through vouchers, tokens, credit cards, tickets, etc. Various mechanisms for entering such vouchers, tokens, credit cards, coins, tickets, etc. are known in the art. For example, coin/symbol input mechanisms, card readers, credit card readers, smart card readers, punch card readers, radio frequency identifier (RFID) readers, and other mechanisms may be used to enter wagers. It is through the user interface 104 that the user can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The display device 102 may include one or more of an electronic display, a mechanical display, and fixed display information such as information such as paytable information associated with a glass/plastic panel on the gaming machine 100. The symbols or other indicia associated with the play of the game may be presented on an electronic display device. Generally, the display 102 devotes the largest portion of viewable area to the primary gaming portion 106. The gaming portion 106 is generally where the visual feedback for any selected game is provided to the user. The gaming portion 106 may render graphical objects such as cards, slot reels, dice, animated characters, and any other gaming visual known in the art. The gaming portion 106 also typically informs players of the outcome of any particular event, including whether the event resulted in a win or loss.

In the particular embodiments illustrated, the gaming portion 106 displays a set of primary reels 108. The reels 108 each include symbols that may be animated so that the symbols appear to be on the surface of a wheel that is rotating vertically when game play is initiated. As is known in the art, when the symbols of the reels stop moving (typically after a random amount of time when physical reel devices are involved), the player may be provided a monetary award if some set of symbols on adjacent reels 108 satisfy some criteria. In addition to these standard play reels, the illustrated play area 106 includes a floating reel strip 110 that “rotates” horizontally as indicated by arrow 112. Generally, this rotation 110 may be simulated using animations, such as by shifting symbols of the floating reel 110 left or right for a predetermined amount of time.

The floating reel 110 includes symbols that interact with the symbols of the primary reels 108. As will be explained in greater detail hereinbelow, the symbols may be wild or non-wild symbols and/or may be similar to the symbols of the primary reels 108. The besides rotating 112 horizontally, the floating reel 110 can translate vertically, as represented by arrow 114. The vertical translation 114 may occur at the same time that the floating reel 110 is horizontally spinning 112. When the floating reel 110 stops spinning 112 and/or translating 114, it is superimposed over the primary reels 108 as indicated by box 116. When superimposed over the primary reels 108, the floating reel 110 may appear to be any combination of transparent, translucent, or opaque in order to produce the desired effect. The cells that contain the symbols of the floating reel 110 may have individual characteristics, e.g., some may be transparent, and others translucent and/or opaque. As such, the effect when the floating reel 110 is superimposed over the primary reels 108 may be any of covering, modifying, or leaving unaffected particular symbols of the primary reels 108.

Although the illustrated embodiment in FIG. 1 is described as a computerized apparatus, the features may be incorporated into mechanical devices as well. This is indicated by supports 118 and bearing rods 120. The symbols of the floating reel 110 may be imprinted on a loop of plastic or other flexible material that is moved horizontally using flexible material handling devices (e.g., spools, rollers, sprockets, etc). The floating reel 110 and any associated devices may also translate vertically relative to the primary wheels 1008 by riding on linear bearings (e.g., pillow block bearings) that slide vertically on the bearing rods 120.

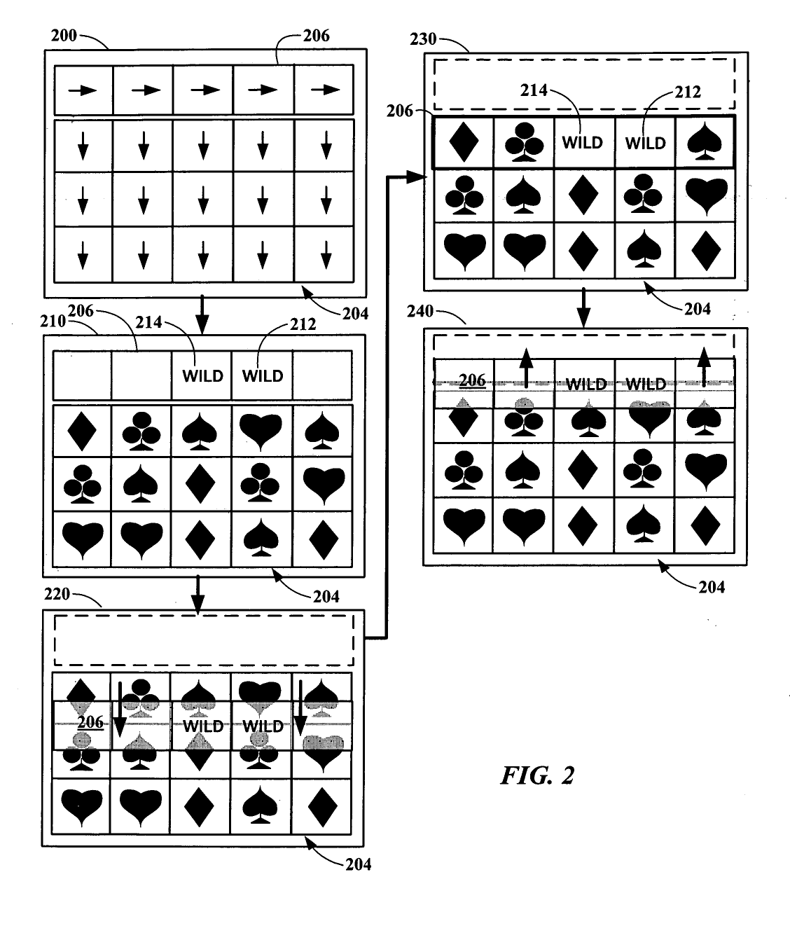

An example of how floating reel game play may proceed is shown in the sequence diagram of FIG. 2. This sequence diagram illustrates various game play states or screens that might be seen in a gaming apparatus according to embodiments of the invention. Screen 200 shows vertical reels 204 and horizontal reel 206 in a spinning state. This screen 200 is typically seen after the player has made a wager and initiated play, such as by pulling a lever or pushing a button. The vertical reels 204 may be considered primary, or base reels, in that they are or appear to be beneath the horizontal, or floating, reel 206 when the floating reel 206 is positioned over the base reels 204. The vertical reels 204 may also be “primary” in that they are part of a gaming activity independent of the floating reel 206.

The horizontal reel 206 may be integrated into the primary play with the vertical reels 204, or as part of a bonus round/game. In other arrangements, the player may make a side bet to enable the horizontal reel 206. The composition of the horizontal reel 206 may be changed based on the amount of such a side wager. For example, the horizontal reel 206 may include wild symbols, and the amount of wild symbols included in the horizontal reel 206 is increased in accordance with an increased wager amount.

In screen 210, the reels 204, 206 have stopped spinning. The horizontal reel 206 shows two wild symbols 212, 214, and the other cells are blank. Next, as seen in screen 220, the floating reel 206 begins to move down over the base vertical reels 204. As seen in screen 230, the floating reel 206 has stopped over one of the rows, and the wild symbols 212, 214 replace the underlying symbols of the primary reels 204. From screen 230, a determination of winnings may be made using the rules of the particular game. For example, some number of matching symbols in a horizontal line may provide payouts according to a pay table. The present invention does not depend on any particular manner of wagering or determination of payout. Once the payout has been determined, the horizontal reel 206 moves back to its top position, as seen in screen 240.

The illustrated sequence of FIG. 2 is exemplary, and many variations are possible. For example, the floating horizontal reel 206 may move over the other reels 204 before or during the time that one or both sets of reels 204, 206 are spinning. In other arrangements, the player may be able to select a row formed by the vertical reels 204 over which to place the horizontal reel 206 before, or during the spin. In yet another configuration, the vertical reels 204 may be spun first, after which the player may be able to increase the wager in order to have the horizontal reel 206 spun. In this latter case, the placement of the horizontal reel may be random or selected by the player.

In other arrangements, the floating reel 206 could stop in multiple locations instead of just one. These extra locations may be dependent on whether or not the player got a payout on a previous floating reel 206 movement. The game may be arranged so that any combination of the floating reel 206 and primary reels 204 spin during each move and/or extra bonus moves. When determining payouts, the base game reels 204 could be evaluated initially before the floating reel strip 206 comes down, and payouts are evaluated again with floating reel 206 in combination with the base reels 204.

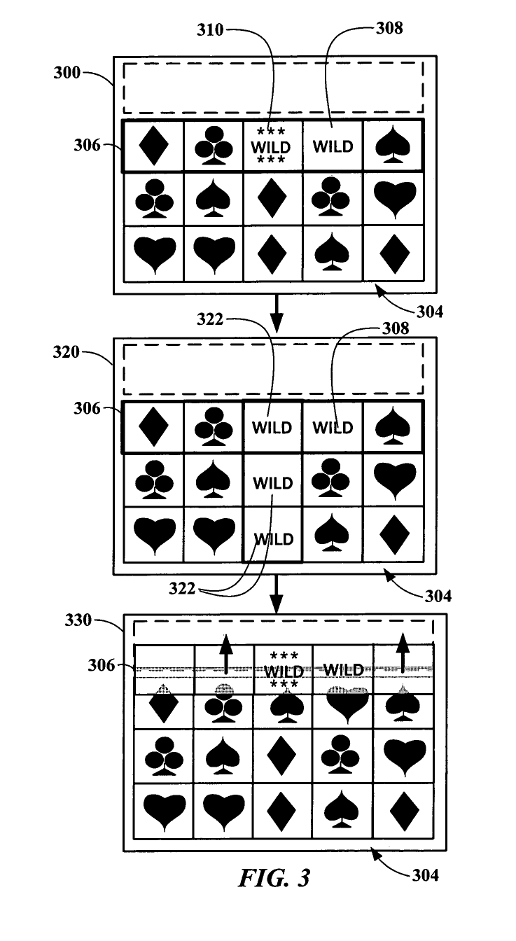

In the sequence of FIG. 2, the wild symbols 212, 214 take on the significance traditionally associated with wild symbols, e.g., the wild symbols may take on any value that results in a winning combination, if such a combination is possible given the placement and value of other wild or non-wild symbols. In reference now to FIG. 3, an alternate wild card option using a floating reel according to an embodiment of the invention is illustrated. Screen 300 shows vertical reels 304 and horizontal reel 306 in a state similar to screen 230 in FIG. 2, where the reels 304, 306 have stopped spinning and the horizontal reel 306 is superimposed over the vertical reels 304. In this example, the horizontal reel includes blank spaces in the same cells as horizontal reel 206 in FIG. 2. In the place of the wild symbols 212, 214 seen in FIG. 2, however, this reel 306 includes both a standard wild symbol 308 (e.g., similar to wild symbols 212, 214) and an expanding wild symbol 310.

The expanding wild symbol 310 acts not only as a regular wild symbol (e.g., can take on any value) but also expands to fill the base reel over which it is superimposed, as is seen in screen 320. The display may transition (e.g., via an animation) from screen 300 to screen 320 by replacing the expanding wild symbol 310 and all other symbols in the same column with regular wild symbols 322 as seen in screen 320. Thereafter, wins may be evaluated, the wild symbols 322 removed, and the horizontal reel is lifted off as seen in screen 330.

In other arrangements, the expanding wild symbol 310 might include multipliers for any pays associated with the symbols 310 or expansion of the symbols 310. The expanding wild symbol 310 may appear initially as shown in the floating horizontal reel 306, or may appear based on other conditions. For example, the base reels 304 may also contain wild symbols similar to symbol 308. In such a case, if a wild symbol 308 from the horizontal reel strip 306 is superimposed over a wild symbol of the base reel, then the expanding wild symbol 310 may appear, and/or the expansion behavior shown in screen 320 may occur.

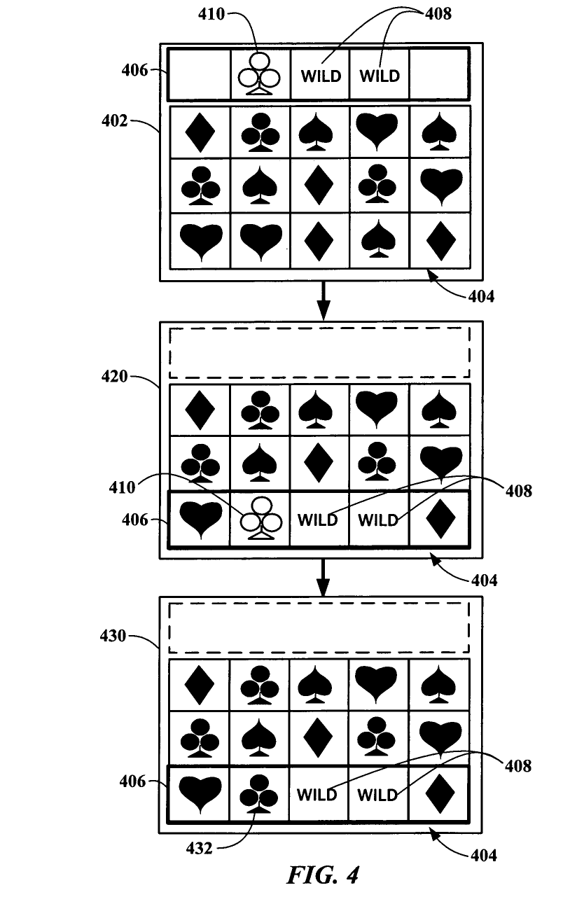

In the previous examples, the floating horizontal reel strip contained various wild card symbols. In reference now to FIG. 4, an alternate arrangement according to an embodiment of the invention uses non-wild symbols in a horizontal reel strip. Game play screen 402 includes vertical reels 404 and horizontal reel 406 that may operate substantially as described above. In this screen 402, the reels 404, 406 have stopped spinning, but the horizontal reel 406 is not yet superimposed over the vertical reels 404. The horizontal reel 406 includes wild symbols 408 and a non-wild symbol 410.

The illustrated non-wild symbol 410 corresponds to one of the symbols from the main reels 404, although may have a somewhat different appearance, such as being transparent, translucent, or being drawn as an outline or silhouette. The non-wild symbol 410 may mirror any symbol used in the game, or possibly only the high symbols. The non-wild silhouette symbol 410 may replace the corresponding symbol underneath the horizontal reel 406 when the reel 406 takes its final position over the vertical reels 404. This is shown in screen 420, which shows the floating horizontal reel 406 positioned over the bottom row of the vertical reels 404.

In screen 420, the silhouette symbol 410 replaces the symbol originally present in this row, as do the wild symbols 408. In one configuration, the silhouette symbol 410 will only replace the underlying symbol if the column in which the silhouette symbol 410 is located has a matching symbol. In this example, there is a club at the top of the column where the silhouetted club 410 has landed, therefore the symbol on the reels 404 underlying this symbol is replaced. This is indicated in screen 430, where the silhouette symbol 410 has been replaced with a regular symbol 432. If the base game reels 404 also include wild symbols, the game may be configured so that wild symbols on the base reels 404 always appear, even if covered by a non-wild symbol 410 when the horizontal reel 406 is overlaid on the base reels 404.

Based on the configuration seen in 430, winning evaluations can evaluated based on the arrangement of symbols. These evaluations may involve determining matches along one or more paylines, or based on other patterns of symbols as defined in the game rules. If a non-wild symbol 410 from the horizontal reel 406 is involved with any payouts, the pays could be multiplied based on the non-wild symbol being involved. After wins are evaluated, the symbol 432 may change back to its previous appearance 410, and the floating reel 406 is moved up and off of the screen.

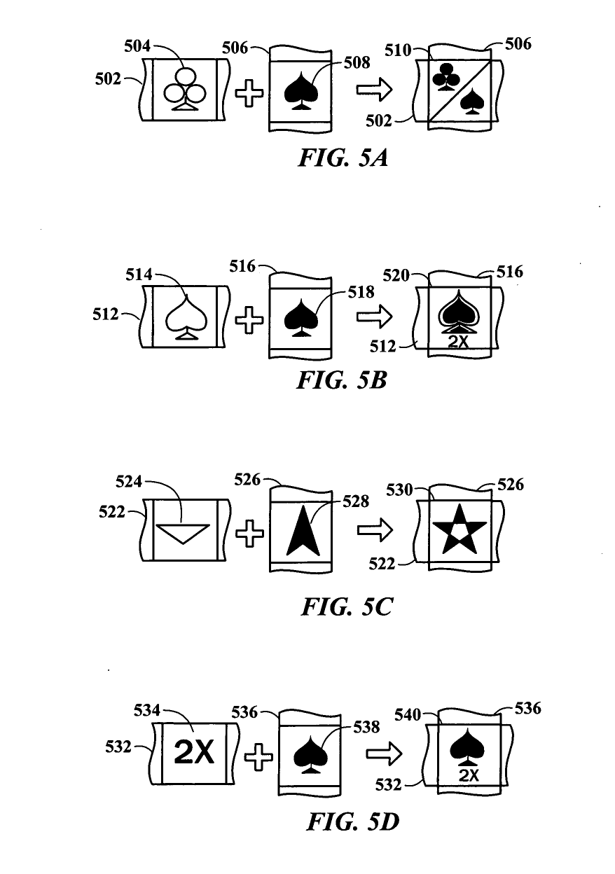

Non-wild symbols in a horizontal reel strip may have alternate behaviors when superimposed over another symbol besides that described in relation to FIG. 4. In FIGS. 5A-D, block diagrams illustrate alternate examples of overlaying non-wild symbols of a floating reel according to embodiments of the invention. In FIG. 5A, a floating reel 502 includes a non-wild club symbol 504. The floating reel 502 is positioned over a base reel 506 which includes spade symbol 508. A composite cell 510 is formed by the floating reel 502 superimposed over the base reel 506. When determining a payout based on the composite cell 510, the cell 510 may take on either value of club or spade when determining one or more payout combinations.

In FIG. 5B, a floating reel 512 having symbol 514 is superimposed over a symbol 518 of a base reel 516 to form composite cell 520. In this example, both symbols 514, 518 are spades. Based on the matching of the symbols, therefore, a multiplier may be applied to any wins, as indicated in composite cell 520. Note that the floating reel symbol 514 may also provide multipliers without matching the underlying symbol 518, however matching of symbols 514, 518 may have some significance to payouts.

In FIG. 5C, a floating reel 522 having symbol 524 is superimposed over a symbol 528 of a base reel 526 to form composite cell 530. The symbols 524, 528 are different from one another, and may have some conventional significance related to combinations of the primary reels. However, when the symbols 524, 526 are superimposed, a new symbol is formed, here a five-pointed star 530, that may have some additional significance. For example, the composite symbol 530 may be treated as any of the other symbols 524, 526, a wild symbol, a multiplier, and/or the player may be provided a monetary award based only on the fact that the symbol was formed.

In FIG. 5D, a floating reel 532 having symbol 534 is superimposed over a symbol 538 of a base reel 536 to form composite cell 540. In this example, the symbol 534 is a multiplier and need not have any conventional significance as far as matching of the game symbols. However, the composite symbol 540 may indicate that any pays associated with this particular symbol 534 is multiplied by the amount shown.

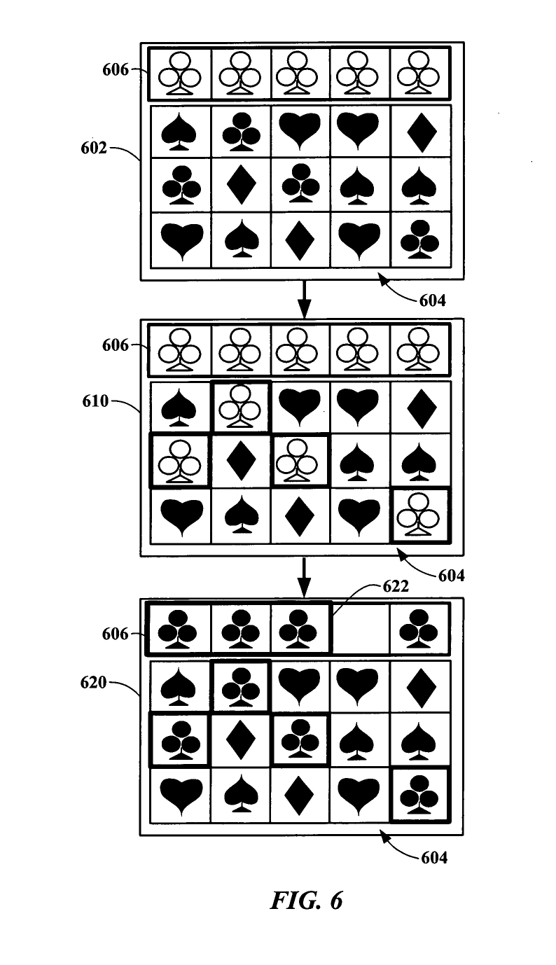

In reference now to FIG. 6, a sequence diagram illustrates another example of a floating reel game according to an embodiment of the invention. Game play screen 602 includes vertical reels 604 and floating horizontal reel strip 606 that may be configured to move over the vertical reels 604. The reels 604, 606 have stopped spinning, and each cell of the horizontal reel 606 is filled across with one symbol selected from the symbols of the base reels 604. In screen 610, all of the base reels 604 are evaluated to determine if any matching symbols are directly below a corresponding symbol of the floating reel 606.

In screen 610, the matching symbols of the base reels 604 are highlighted by boldface outlining of the corresponding cells. Numerous other ways may be used to illustrate this matching during game play. For example, the horizontal reel 606 may move downward over the vertical reels 604, and each time a matching symbol below is encountered, the symbols of the horizontal reel 606 change color and/or appearance.

Screen 620 shows how the horizontal reel 606 may appear after the matching of symbols has been performed. The outlined area 622 encompasses three clubs in a row, and may provide a payout to the player. This payout may be instead of or in addition to any payouts associated with the vertical reels 604. This type of activity may be part of bonus play or part of primary game play.

It will be appreciated that there may be many variations on the specifics of games described in relation to the previous figures. For example, a floating reel may be formed using other regions besides a strip or row. For example, the floating reel could be composed of squares, rectangles, 3-D shapes, or any arbitrary continuous or non-contiguous shape. Spinning of these floating reels may involve shifting symbols between adjacent locations, randomly changes cells of the reels, etc. The reel itself may undergo any combination of out-of-game-spin-axis rotation or translation when being superimposed over the base reels.

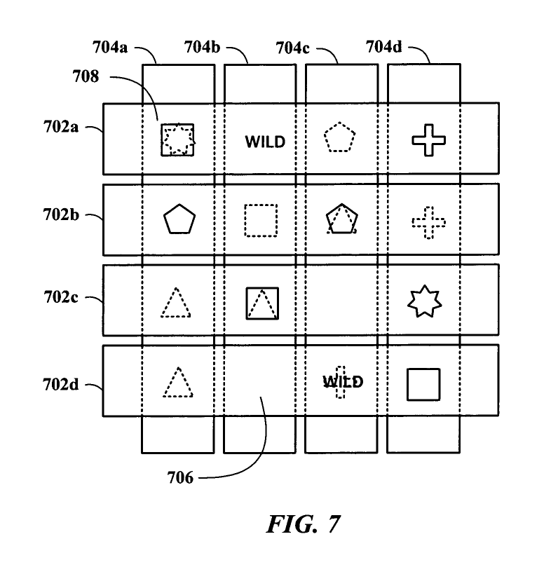

Although the base reels in the illustrated embodiments are shown “spinning” vertically and the floating reel “spinning” horizontally, the inverse arrangement may also be possible. Further, the floating reel may be diagonal or have any other orientation that will interface with the underlying base reels. In another arrangement, the game may include multiple floating reels. For example, a game may include m-base reels and n-floating reels, such that the gaming field appears as an m by n grid. This may be seen in FIG. 7, where an arrangement with multiple floating reels is illustrated according to an example embodiment of the invention.

The diagram in FIG. 7 illustrates a game with four floating reels 702a-d and four base reels 704a-d. The floating reels 702a-d may be fixed or randomly assigned a position over the base reels 704a-d during the spin. Similarly, the base reels 704a-d may also be able to change relative position. Symbols of the base reels 704a-d are drawn with dotted lines and symbols of the floating reels 702a-d are drawn with solid lines. In the illustrated arrangement, the base reels 704a-d and floating reels 702a-d may both include blank spaces, such that the resulting grid may also have blank spaces where two blank cells overlap (e.g., cell 706).

Where a particular grid cell is populated by a symbol on the base reel 704a-d and a symbol on a floating reel 702a-d, the dominant symbol (e.g., the symbol used to evaluate winnings) may be automatically determined, or determined based on user selections before the spin. For example, cell 708 includes a square symbol of floating reel 702a superimposed over star symbol of base reel 704a. Either one of the star symbol or the square symbol of the floating reel 702a may dominate (e.g., used to evaluate wins) based on some predetermined criteria. This criteria may be based in which reel has the symbol (e.g., floating reels 702a-d may always dominate) and/or may be based on the values of the symbols (e.g., wild symbols always dominate, user may select one symbol that always dominates, high/low symbol dominates, etc.). In other arrangements, the symbols in this cell 708 may be combined and/or used to determine multipliers in other ways as is described hereinabove.

It will be appreciated that the floating reels 702a-d and base reels 704a-d may be fully populated with symbols (e.g., no blank cells) similar to previously described arrangements. For example, the base reels 704a-d may be entirely filled with symbols and the floating reels are partially filled with wild and/or non-wild symbols. Further, the floating reels 702a-d may be part of primary game play, or may be part of bonus round play. The player may be able to pre-activate some or all of the floating reels 702a-b during game play, such as by wagering additional bets to activate the reels.

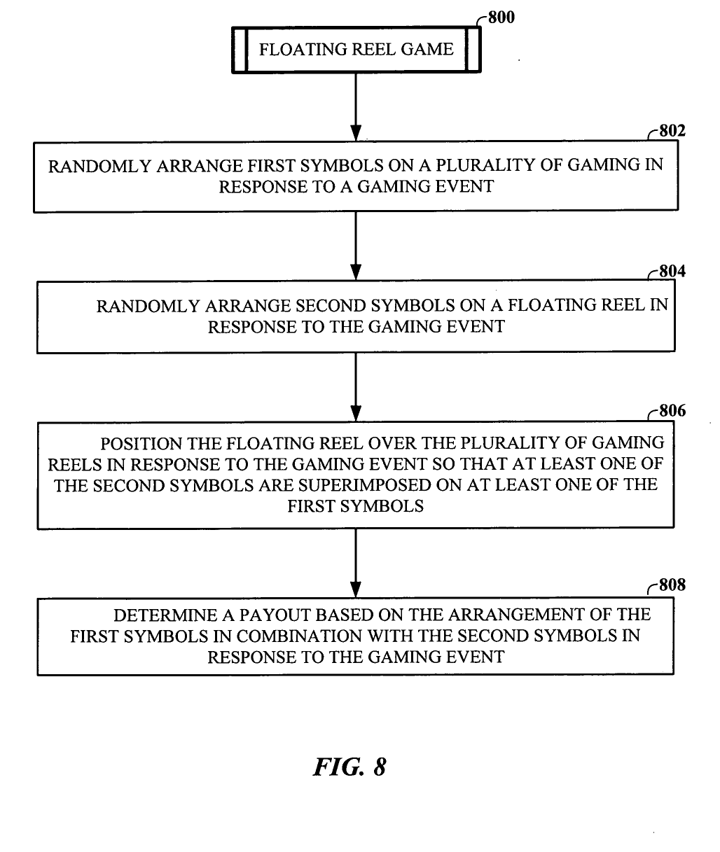

In reference now to FIG. 8, an example procedure 800 is illustrated for providing a gaming experience according to embodiments of the invention. First symbols are randomly arranged 802 on a plurality of gaming reels in response to a gaming event, and second symbols are randomly arranged 802, 804 on a floating reel in response to the gaming event. The symbols of either may be printed on a surface of a physical object (e.g., reel, tape), such that the random arrangements 802, 804 result from spinning each reel object for a random amount of time. In a computerized apparatus, the random arrangements 802, 804 may involve simulating a spinning action such as by shifting symbols in a linear path. Alternatively, each cell containing a symbol may be individually randomized.

The floating reel is positioned 806 over the plurality of gaming reels in response to the gaming event so that at least one of the second symbols are superimposed on at least one of the first symbols. This positioning 806 may occur before, during, or after any of the randomization 802, 804 of one or both of the reels, and may occur multiple times. A payout is determined 808 based on the arrangement of the first symbols in combination with the second symbols in response to the gaming event. The payout may be a primary payout and a bonus payout. For example, the game may provide a primary payout that involves only determining an arrangement of the primary reels, and the bonus payout may involve the combination formed by the gaming reels and floating reel.

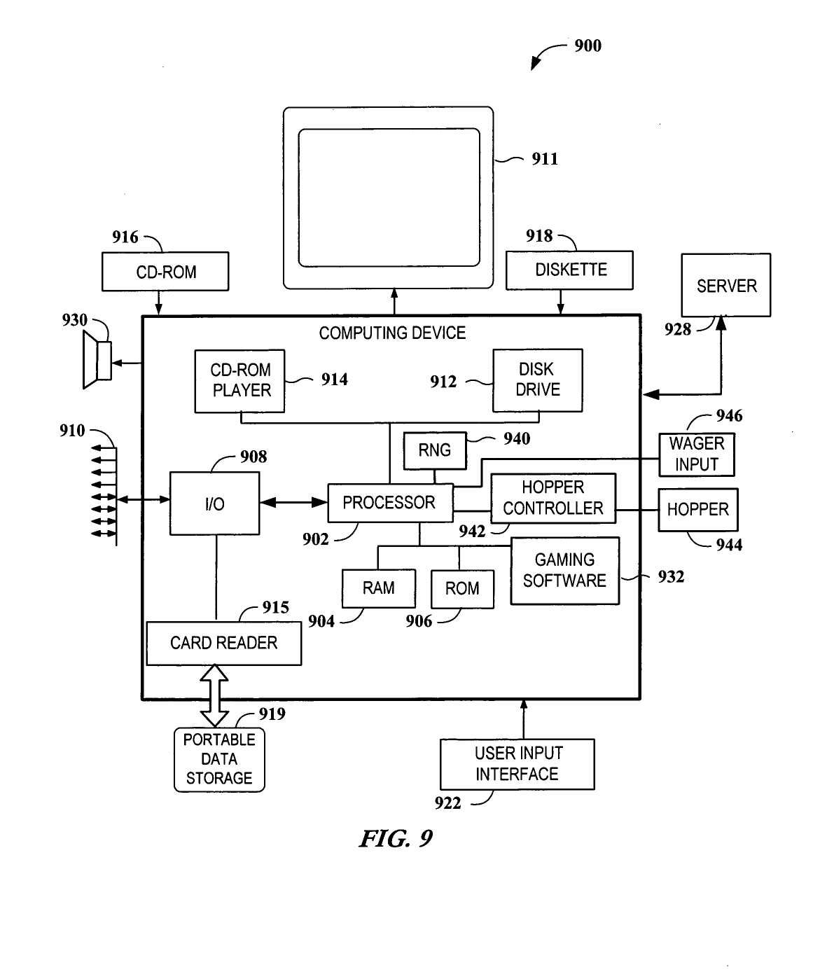

As may now be readily understood, one or more devices may be programmed to play various embodiments of the invention. The present invention may be implemented as a casino gaming machine such as a slot machine or other special purpose gaming kiosk as described hereinabove, or may be implemented via computing systems operating under the direction of local gaming software, and/or remotely-provided software such as provided by an application service provider (ASP). The casino gaming machines utilize computing systems to control and manage the gaming activity. An example of a representative computing system capable of carrying out operations in accordance with the invention is illustrated in FIG. 9.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 900 of FIG. 9 is an example computing structure that can be used in connection with such electronic gaming machines, computers, or other computer-implemented devices to carry out operations of the present invention.

The example computing arrangement 900 suitable for performing the gaming functions in accordance with the present invention typically includes a central processor (CPU) 902 coupled to random access memory (RAM) 904 and some variation of read-only memory (ROM) 906. The ROM 906 may also represent other types of storage media to store programs, such as programmable ROM (PROM), erasable PROM (EPROM), etc. The processor 902 may communicate with other internal and external components through input/output (I/O) circuitry 908 and bussing 910, to provide control signals, communication signals, and the like.

The computing arrangement 900 may also include one or more data storage devices, including hard and floppy disk drives 912, CD-ROM drives 914, card reader 915, and other hardware capable of reading and/or storing information such as DVD, etc. In one embodiment, software for carrying out the operations in accordance with the present invention may be stored and distributed on a CD-ROM 916, diskette 918, access card 919, or other form of media capable of portably storing information. These storage media may be inserted into, and read by, devices such as the CD-ROM drive 914, the disk drive 912, card reader 915, etc. The software may also be transmitted to the computing arrangement 900 via data signals, such as being downloaded electronically via a network, such as the Internet. Further, as previously described, the software for carrying out the functions associated with the present invention may alternatively be stored in internal memory/storage of the computing device 900, such as in the ROM 906.

The computing arrangement 900 is coupled to the display 911, which represents a display on which the gaming activities in accordance with the invention are presented. The display 911 represents the “presentation” of the video information in accordance with the invention, and may be any type of known display or presentation screen, such as LCD displays, plasma display, cathode ray tubes (CRT), digital light processing (DLP), liquid crystal on silicon (LCOS), etc.

Where the computing device 900 represents a stand-alone or networked computer, the display 911 may represent a standard computer terminal or display capable of displaying multiple windows, frames, etc. Where the computing device is embedded within an electronic gaming machine, the display 911 corresponds to the display screen of the gaming machine/kiosk. A user input interface 922 such as a mouse, keyboard/keypad, microphone, touch pad, trackball, joystick, touch screen, voice-recognition system, etc. may be provided. The display 911 may also act as a user input device, e.g., where the display 911 is a touchscreen device.

Chance-based gaming systems such as slot machines, in which the present invention is applicable, are governed by random numbers and processors, as facilitated by a random number generator (RNG). The fixed and dynamic symbols generated as part of a gaming activity may be produced using one or more RNGs. RNGs as known in the art may be implemented using hardware, software operable in connection with the processor 902, or some combination of hardware and software. The present invention is operable using any known RNG, and may be integrally programmed as part of the processor 902 operation, or alternatively may be a separate RNG controller 940.

The computing arrangement 900 may be connected to other computing devices or gaming machines, such as via a network. The computing arrangement 900 may be connected to a network server 928 in an intranet or local network configuration. The computer may further be part of a larger network configuration as in a global area network (GAN) such as the Internet. In such a case, the computer may have access to one or more web servers via the Internet.

Other components directed to gaming machine implementations include manners of gaming participant payment, and gaming machine payout. For example, a gaming machine including the computing arrangement 900 may also include a hopper controller 942 to determine the amount of payout to be provided to the participant. The hopper controller may be integrally implemented with the processor 902, or alternatively as a separate hopper controller 942. A hopper 944 may also be provided in gaming machine embodiments, where the hopper serves as the mechanism holding the coins/tokens of the machine. The wager input module 946 represents any mechanism for accepting coins, tokens, coupons, bills, electronic fund transfer (EFT), tickets, credit cards, smart cards, membership cards, etc., for which a participant inputs a wager amount. It will be appreciated that the primary gaming software 932 may be able to control payouts via the hopper 944 and controller 942 for independently determined payout events.

Among other functions, the computing arrangement 900 provides an interactive experience to players via input interface 922 and output devices, such as the display 911, speaker 930, etc. These experiences are generally controlled by gaming software 932 that controls a primary gaming activity of the computing arrangement 900. The gaming software 932 may be temporarily loaded into RAM 904, and may be stored locally using any combination of ROM 906, drives 912, or media player 914. The primary gaming software 932 may also be accessed remotely, such as via the server 928 or the Internet.

The primary gaming software 932 in the computing arrangement 900 according to embodiments of the present invention provides a floating reel-type gaming experience as defined hereinabove. For example, the software 932 may present, by way of the display 911, a plurality of gaming reels and a floating reel. The primary reels each have a plurality of first symbols that are randomly arranged in response to a gaming event, and the floating reel also has a plurality of second symbols that are randomly arranged in response to the gaming event.

The software causes the floating reel to be overlaid on the plurality of gaming reels in response to the gaming event so that at least one of the second symbols are superimposed at least one of the first symbols. This overlay may be accomplished using computer video display techniques that are well known in the art, including simulation of transparent/translucent layers and/or 3-D objects. The software 932 may also provide, by way of the hopper controller 942, a monetary award to the player based on the arrangement of the first symbols in combination with the second symbols in response to the gaming event.

The foregoing description of the exemplary embodiments of the invention has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of the gaming activities. It is intended that the scope of the invention be limited not with this detailed description, but rather determined from the claims appended hereto.

What is claimed is:

1. A gaming apparatus comprising:
a plurality of gaming reels each having a plurality of first symbols that are randomly arranged in response to a gaming event;
a floating reel having a plurality of second symbols that are randomly arranged in response to the gaming event, and wherein the floating reel is overlaid on the plurality of gaming reels in response to the gaming event so that at least one of the second symbols are superimposed at least one of the first symbols; and
a payout device that determines a payout based on the arrangement of the first symbols in combination with the second symbols in response to the gaming event.

2. The gaming apparatus of claim 1, wherein the at least one second symbol replaces the at least one first symbol, and wherein the payout device determines the payout based on the replacement of the at least one first symbol by at least one the second symbol.

3. The gaming apparatus of claim 1, wherein the at least one second symbol comprises a wild symbol.

4. The gaming apparatus of claim 1, wherein the at least one second symbol is combined with the at least one first symbol to create a composite symbol, and wherein the payout device determines the payout based on the composite symbol.

5. The gaming apparatus of claim 4, wherein the composite symbol is capable of taking on either value of the at least one first and second symbols when the payout is determined.

6. The gaming apparatus of claim 4, wherein the composite symbol causes a multiplier to be applied when the payout is determined for any payouts associated with the composite symbol.

7. The gaming apparatus of claim 1, wherein the floating reel contains a plurality of cells filled each filled with the same selected symbol, and wherein a first set of the cells are defined based on the selected symbols of the first set of cells matching at least one of the first symbols over which the selected symbols are respectively superimposed when the floating reel is overlaid on the plurality of gaming reels, and wherein the payout device determines the payout based on the first set of cells.

8. The gaming apparatus of claim 1, wherein the at least one second symbol comprises an expanding wild symbols that causes all symbols of a gaming reel of the plurality of gaming reels over which the expanding wild symbol is superimposed to change to wild symbols.

9. The gaming apparatus of claim 1, wherein the gaming event comprises a primary game event and a bonus game event, and wherein the floating reel is overlaid on the plurality of gaming reels in response to the bonus game event and wherein the payout device determines the payout based on the arrangement of the first symbols in combination with the second symbols in response to the bonus game event.

10. The gaming apparatus of claim 1, wherein the plurality of gaming reels are disposed vertically and the floating reel is disposed horizontally, and wherein the floating reel is overlaid on the plurality of gaming reels based on a vertical translation of the floating reel.

11. A method comprising:
randomly arranging first symbols on a plurality of gaming reels in response to a gaming event;
randomly arranging second symbols on a floating reel in response to the gaming event;
positioning the floating reel over the plurality of gaming reels in response to the gaming event so that at least one of the second symbols are superimposed on at least one of the first symbols; and
determining, in response to the gaming event, a payout based on the arrangement of the first symbols in combination with the second symbols.

12. The method of claim 11, wherein the at least one second symbol replaces the at least one first symbol, and wherein the payout is determined based on the replacement of the at least one first symbol by at least one the second symbol.

13. The method of claim 11, wherein the at least one second symbol comprises a wild symbol.

14. The method of claim 11, wherein at the least one of the portion of second symbols is combined with the at least one first symbol to create a composite symbol, and wherein the payout is determined based on the composite symbol.

15. The method of claim 14, wherein the composite symbol is capable of taking on either value of the at least one first and second symbols when the payout is determined.

16. The method of claim 14, wherein the composite symbol causes a multiplier to be applied when the payout is determined for any payouts associated with the composite symbol.

17. The method of claim 11, wherein the floating reel contains a plurality of cells filled each filled with the same selected symbol, and wherein the method further comprises defining a first set of the cells based on the selected symbols of the first set of cells matching at least one of the first symbols over which the selected symbols are respectively superimposed when the floating reel is overlaid on the plurality of gaming reels, and wherein the payout is determined based on the first set of cells.

18. The method of claim 11, wherein the floating reel is disposed substantially perpendicular to the plurality of gaming reels.

19. The method of claim 11, wherein the plurality of gaming reels are disposed vertically and the floating reel is disposed horizontally, and wherein positioning the floating reel over the plurality of gaming reels comprises vertically translating the floating reel.

20. A gaming system comprising:
means for randomly arranging first symbols in response to a gaming event;
means for randomly arranging second symbols so that at least one of the second symbols are superimposed on at least one of the first symbols in response to the gaming event; and
means for determining, in response to the gaming event, a payout based on the arrangement of the first symbols in combination with the second symbols.
